(19) United States
(12) Patent Application Publication
(10) Pub. No.: US 2026/0246209 A1
(43) Pub. Date: Aug. 20, 2026

(54) TERMINAL MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yu KATO, Osaka (JP); Toshifumi ICHIO, Osaka (JP)

(21) Appl. No.: 19/489,592

(22) PCT Filed: May 29, 2024
(86) PCT No.: PCT/JP2024/019766

§ 371 Date: Dec. 3, 2025

(30) Foreign Application Priority Data
Jun. 7, 2023 (JP) 2023-093735

(51) Int. Cl. H01R 13/6591

(52) U.S. Cl. CPC H01R 13/65912

(57) ABSTRACT

A terminal module (10, 10A, 10B, 10C, 10D, 10E) comprises: a shield wire (20) having a shield part (22) from which the end of a covered wire (21) is exposed; a terminal (30, 30D, 30E) connected to the end of the covered wire (21); a conductive impedance adjustment member (40) that covers the end region of the covered wire (21); and an insulating spacer member (50, 50A, 50B, 50C, 50D, 50E) that maintains an interval between the terminal (30, 30D, 30E) and the impedance adjustment member (40).

### TECHNICAL FIELD

The present disclosure relates to a terminal module.

### BACKGROUND

A terminal module disclosed in Patent Document 1 is provided with a shielded cable, a terminal (inner conductor) to be connected to a coated wire exposed from a shield portion in an end part of the shielded cable and an impedance adjusting member for covering the coated wire exposed from the shield portion. The impedance adjusting member has a function of suppressing an impedance change between a part covered by the shield portion and a part not covered by the shield portion in the coated wire.

### PRIOR ART DOCUMENT

### Patent Document

### Patent Document 1: JP 2021-106168 A

### SUMMARY OF THE INVENTION

### Problems to be Solved

By arranging the impedance adjusting member near the terminal, the function of suppressing an impedance change can be effectively exhibited. In contrast, when the terminal and the impedance adjusting member approach until contacting each other (short-circuiting to each other) or when a gap between the terminal and the impedance adjusting member cannot be kept constant, there is a concern that an impedance is disturbed and it becomes difficult to suppress an impedance variation.

Accordingly, the present disclosure aims to provide a terminal module capable of suppressing an impedance variation.

### Means to Solve the Problem

The present disclosure is directed to a terminal module with a shielded cable configured such that an end part of a coated wire is exposed from a shield portion, a terminal to be connected to the end part of the coated wire, an electrically conductive impedance adjusting member for covering an end region of the coated wire, and an insulating spacer member for keeping a gap between the terminal and the impedance adjusting member.

### Effect of the Invention

According to the present disclosure, it is possible to provide a terminal module capable of suppressing an impedance variation.

### BRIEF DESCRIPTION OF THE DRAWINGS

FIG. 1 is a perspective view of a terminal module according to a first embodiment.

FIG. 2 is an exploded perspective view of the terminal module according to the first embodiment.

FIG. 3 is a side view in section of the terminal module according to the first embodiment.

FIG. 4 is a transverse section of the terminal module according to the first embodiment.

FIG. 5 is a perspective view showing a state where a gap between an insulation barrel portion of each terminal and an impedance adjusting member is kept by individually covering an end region of each coated wire by each spacer member in the terminal module according to the first embodiment.

FIG. 6 is a perspective view of the impedance adjusting member in the terminal module according to the first embodiment.

FIG. 7 is a transverse section of a terminal module according to a second embodiment.

FIG. 8 is a perspective view showing a state where gaps between insulation barrel portions of terminals and an impedance adjusting member are kept by collectively covering end regions of coated wires by a spacer member in the terminal module according to the second embodiment.

FIG. 9 is a side view in section of a terminal module according to a third embodiment.

FIG. 10 is a perspective view showing a state where a gap between an insulation barrel portion of each terminal and an impedance adjusting member is kept by individually covering an end region of each coated wire by each spacer member including a fixing portion in the terminal module according to the third embodiment.

FIG. 11 is a perspective view showing a state where gaps between insulation barrel portions of terminals and an impedance adjusting member are kept by collectively covering end regions of coated wires by a spacer member including two fixing portions in a terminal module according to a fourth embodiment.

FIG. 12 is a perspective view showing a state where a gap between a wire barrel portion of each terminal and an impedance adjusting member is kept by individually covering an end region of each coated wire by each spacer member in a terminal module according to a fifth embodiment.

FIG. 13 is a perspective view showing a state where gaps between wire barrel portions of terminals and an impedance adjusting member are kept by collectively covering end regions of coated wires by a spacer member in a terminal module according to a sixth embodiment.

### DETAILED DESCRIPTION TO EXECUTE THE INVENTION

### Description of Embodiments of Present Disclosure

First, embodiments of the present disclosure are listed and described.

(1) The terminal module of the present disclosure is provided with a shielded cable configured such that an end part of a coated wire is exposed from a shield portion, a terminal to be connected to the end part of the coated wire, an electrically conductive impedance adjusting member for covering an end region of the coated wire, and an insulating spacer member for keeping a gap between the terminal and the impedance adjusting member.

Since the contact (short circuit) of the terminal and the impedance adjusting member can be prevented and the gap between the terminal and the impedance adjusting member can be kept constant by the insulating spacer member in the configuration of (1) described above, an impedance variation can be suppressed.

(2) In the terminal module of (1) described above, the spacer member is preferably a tubular member for covering the end region of the coated wire between the terminal and the impedance adjusting member.

In the configuration of (2) described above, signal reflection in the end part of the coated wire can be effectively suppressed.

(3) In the terminal module of (1) or (2) described above, the spacer member is preferably arranged with a position shift in a length direction of the coated wire restricted by the terminal and the impedance adjusting member.

In the configuration of (3) described above, the spacer member can be sandwiched and held between the terminal and the impedance adjusting member.

(4) In the terminal module of any one of (1) to (3) described above, preferably, an insulating terminal accommodating member for accommodating the terminal is further provided, and the terminal accommodating member includes a spacer accommodating portion for accommodating the spacer member with movements of the spacer member restricted.

In the configuration of (4) described above, since the rattling of the spacer member accommodated in the spacer accommodating portion of the terminal accommodating member can be restricted, an impedance variation can be more effectively suppressed.

(5) In the terminal module of (4) described above, preferably, at least two terminals are accommodated in the terminal accommodating member, and the spacer members are provided to individually cover the respective end regions of the coated wires extending from the two terminals.

In the configuration of (5) described above, for example, if one coated wire, out of the coated wires extending from the two terminals, is changed, it is sufficient to exchange only the spacer member corresponding to the one coated wire and the spacer member corresponding to the other coated wire needs not be exchanged.

(6) In the terminal module of (4) described above, preferably, at least two terminals are accommodated in the terminal accommodating member, and the spacer member is integrally provided to collectively cover the respective end regions of the coated wires extending from the two terminals.

In the configuration of (6) described above, since a distance between the end parts of the coated wires extending from the two terminals can be kept constant by the spacer member, the occurrence of crosstalk and the like can be prevented and impedance matching can be improved.

(7) In the terminal module of any one of (4) to (6) described above, preferably, the terminal includes a barrel portion for holding the end part of the coated wire, and the spacer member includes a fixing portion to be sandwiched and fixed in a radial direction of the coated wire between the end part of the coated wire and the barrel portion.

In the configuration of (7) described above, since the relative position of the spacer member with respect to each of the coated wire and the terminal can be kept constant, an impedance variation can be more effectively suppressed.

(8) In the terminal module of (7) described above, preferably, the coated wire includes a core wire and an insulation coating surrounding an outer periphery of the core wire, and the fixing portion has a tubular shape for covering the core wire projecting from the insulation coating in the end part of the coated wire.

In the configuration of (8) described above, the barrel portion can hold the core wire via the fixing portion and the fixing portion can fulfill a function of the insulation coating of the coated wire.

### Details of Embodiments of Present Disclosure

Specific examples of the present disclosure are described below with reference to the drawings. Note that the present invention is not limited to this illustration, but is represented by claims and intended to include all changes in the scope of claims and in the meaning and scope of equivalents.

### First Embodiment

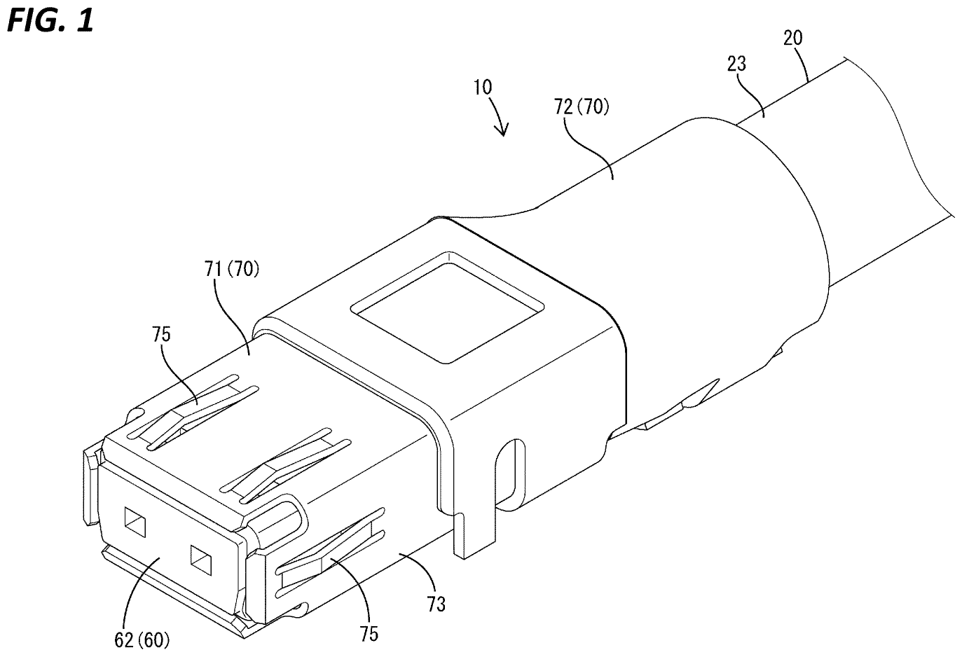

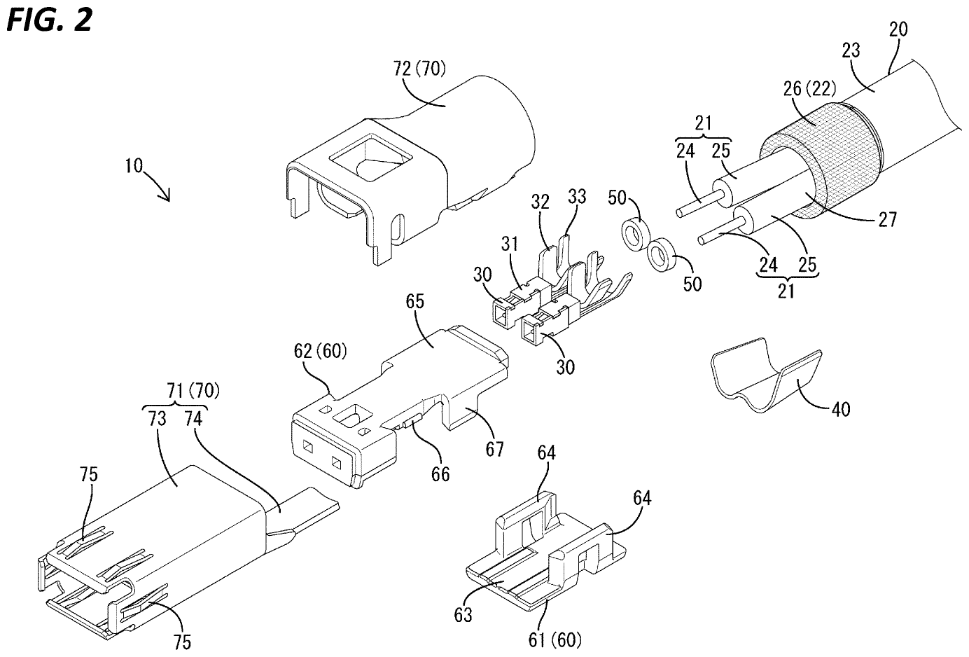

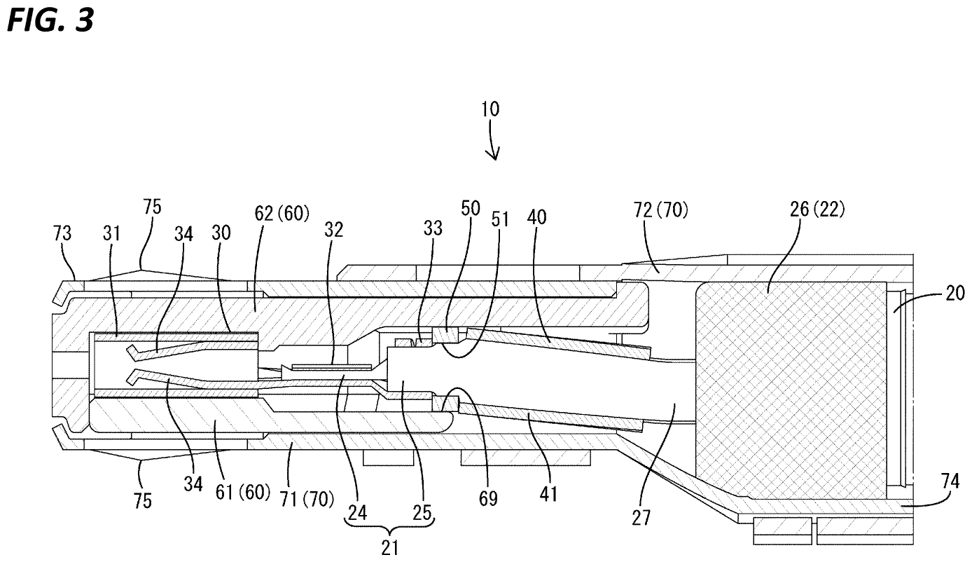

A first embodiment of the present disclosure illustrates a terminal module 10 for communication in a vehicle such as an electric vehicle or a hybrid vehicle. A terminal module 10 according to the first embodiment is, as shown in FIGS. 2 and 3, provided with a shielded cable 20, terminals 30, an impedance adjusting member 40, spacer members 50, a terminal accommodating member 60 and an outer conductor 70. The terminal module 10 is accommodated into an unillustrated housing. Note that, in the following description, a tip side in a length direction of the shielded cable 20 is referred to as a front side concerning a front-rear direction. A vertical direction is based on that of each of FIGS. 1 to 6. These directions do not necessarily coincide with direction references in a state where the terminal module 10 is installed in an unillustrated vehicle or the like.

### (Shielded Cable)

The shielded cable 20 includes, as shown in FIG. 2, two coated wires 21, a shield portion 22 collectively surrounding the outer peripheries of the respective coated wires 21, and a sheath 23 surrounding the outer periphery of the shield portion 22. The shield portion 22 is a braided wire formed by braiding a plurality of metal strands into a tube. The shield portion 22 may be a metal foil such as a copper foil.

The two coated wires 21 constitute, for example, a twisted pair cable. Each coated wire 21 includes a core wire 24, which is a conductor, and an insulation coating 25 surrounding the outer periphery of the core wire 24. The core wire 24 is, for example, made of a metal material such as copper, copper alloy, aluminum or aluminum alloy. The core wire 24 may be one metal strand or may be a stranded wire formed by twisting a plurality of metal strands. The sheath 23 and the insulation coating 25 are made of synthetic resin and have insulating property and flexibility. End processing (stripping) is applied to an end part (front end part, terminal end) of the shielded cable 20. Specifically, the sheath 23 is removed in the end part of the shielded cable 20 by end processing to expose end parts of the respective coated wires 21 and the braided wire. Out of the shield portion 22, a part extending and exposed from the front end of the sheath 23 is folded rearward to form a turnover portion 26 covering the outer peripheral surface of the sheath 23. The end part of each coated wire 21 forms an exposed portion 27 exposed forward from the turnover portion 26 of the shield portion 22. The insulation coating 25 is removed by end processing such as stripping in an end part of the exposed portion 27 to expose the core wire 24. The exposed portion 27 is covered by the impedance adjusting member 40 and constitutes an end region of the coated wire 21. The end region of the coated wire 21 is also covered by the spacer member 50. In the case of the first embodiment, the end region of the coated wire 21 is constituted by the insulation coating 25 of the exposed portion 27.

### (Terminal)

The terminal 30 is an inner conductor to be arranged inside the outer conductor 70. The terminal 30 is integrally formed, such as by bending an electrically conductive metal plate material. As shown in FIG. 2, the terminal 30 is provided to be connectable to each of the two coated wires 21, and two terminals 30 are provided in one terminal module 10. The terminal 30 includes a mating connecting portion 31 to be connected to an unillustrated mating terminal (mating inner conductor) in a front part and a barrel portion 32, 33 to be connected to the exposed portion 27 of the coated wire 21 in a rear part.

As shown in FIG. 3, the mating connecting portion 31 includes a pair of resiliently deformable upper and lower connection pieces 34 inside. Each connection piece 34 is resiliently deformable and connected to a tab of the unillustrated mating terminal inserted into the mating connecting portion 31.

The barrel portion includes a wire barrel portion 32 and an insulation barrel portion 33 arranged side by side with the wire barrel portion 32 behind the wire barrel portion 32. The wire barrel portion 32 and the insulation barrel portion 33 are both in the form of an open barrel.

The wire barrel portion 32 is crimped to wind around the core wire 24 exposed in the end part of the exposed portion 27 and electrically and mechanically connected to the core wire 24. The insulation barrel portion 33 is crimped to wind around the insulation coating 25 exposed in the end part of the exposed portion 27 and electrically and mechanically connected to the insulation coating 25.

### (Impedance Adjusting Member)

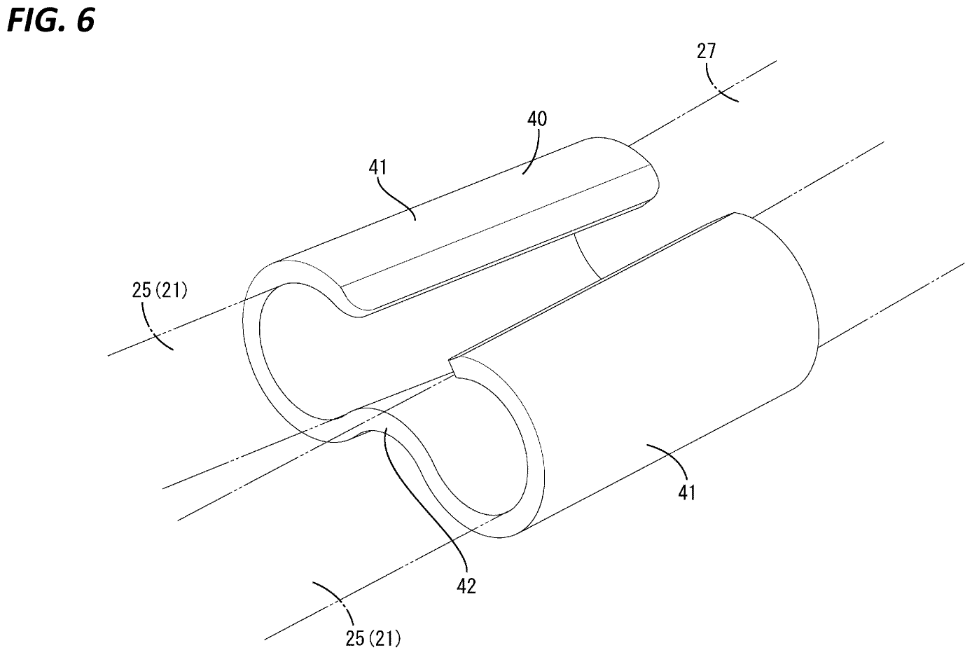

The impedance adjusting member 40 is integrally formed, such as by bending an electrically conductive metal plate. As shown in FIG. 6, the impedance adjusting member 40 includes a pair of left and right adjusting body portions 41 for covering the insulation coatings 25 of the exposed portions 27, which are end regions of the respective coated wires 21, and a coupling portion 42 coupling the respective adjusting body portions 41. Each adjusting body portion 41 has a hollow cylindrical shape having a C-shaped cross-section, and bent along the outer peripheral surface of the coated wire 25 from an open state shown in FIG. 2. The outer periphery of the insulation coating 25 is covered by the adjusting body portion 41. The coupling portion 42 is arranged between the respective adjusting body portions 41 and has an upwardly curved shape.

### (Spacer Member)

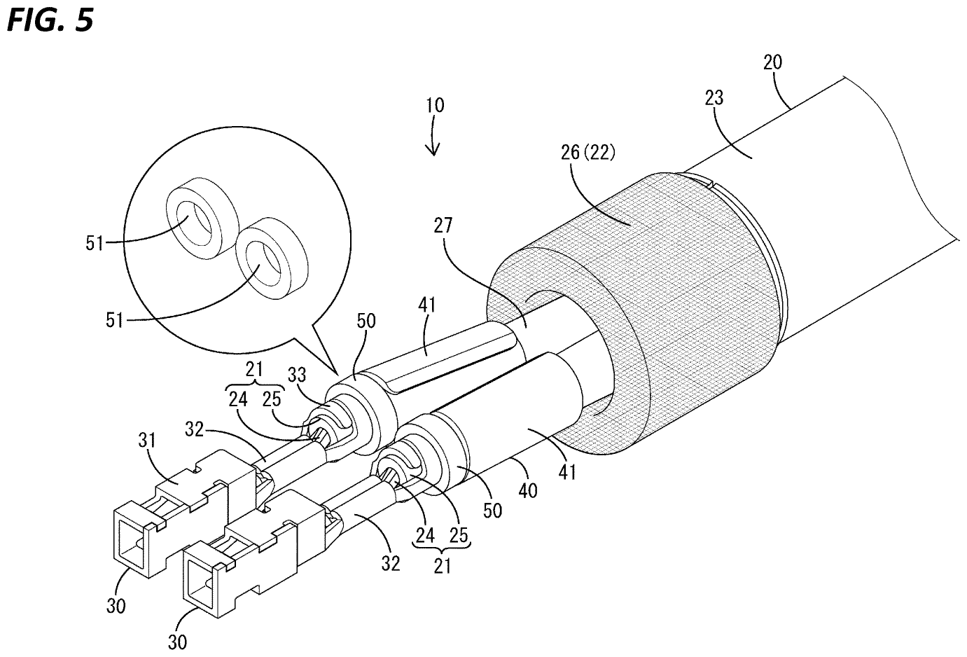

The spacer member 50 is made of synthetic resin and has insulating property. In the case of the first embodiment, two spacer members 50 are provided to respectively individually correspond to the two coated wires 21 as shown in FIG. 5. The spacer member 50 has a tubular or annular shape, e.g. a hollow cylindrical shape or a circular ring shape, for covering the end region of the coated wire 21 between the terminal 30 and the impedance adjusting member 40. The spacer member 50 includes a wire insertion hole 51. The wire insertion hole 51 has an inner diameter corresponding to an outer diameter of the insulation coating 25 of the exposed portion 27. The spacer member 50 is fit to the insulation coating 25 of the exposed portion 27. In the case of the first embodiment, the spacer member 50 includes the wire insertion hole 51 having the inner diameter smaller than the outer diameter of the insulation coating 25, and is fit to the insulation coating 25 while compressing the insulation coating 25 in a radial direction (see FIG. 3).

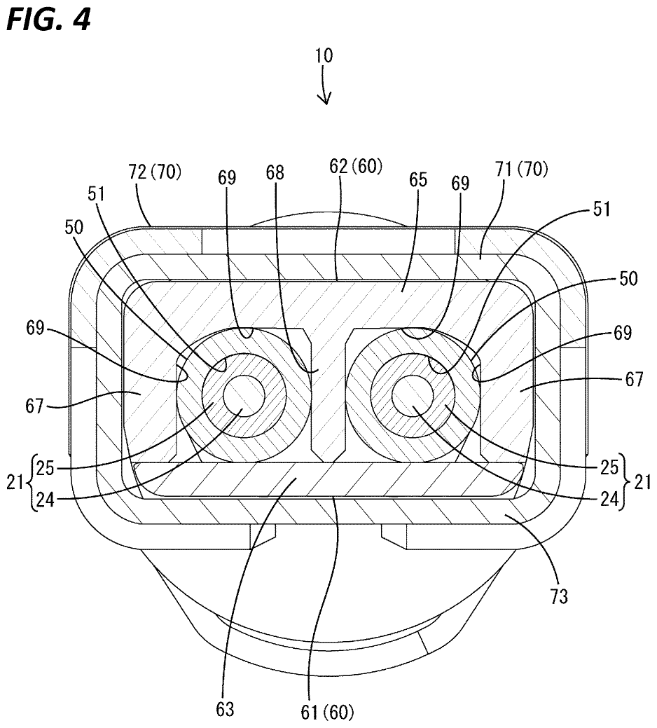

Further, the spacer member 50 has an outer diameter equal to or smaller than an outer diameter of the adjusting body portion 41 and is accommodated in a later-described spacer accommodating portion 69 of the terminal accommodating member 60 with movements restricted (see FIG. 4). The front and rear surfaces of the spacer member 50 are both formed along a radial direction of the spacer member 50. As shown in FIG. 3, with the spacer member 50 accommodated in the spacer accommodating portion 69, the front surface of the spacer member 50 is arranged to be able to contact the rear end surface of the terminal 30; in the case of the first embodiment, the rear end surface of the insulation barrel portion 33. Further, with the spacer member 50 accommodated in the spacer accommodating portion 69, the rear surface of the spacer member 50 is arranged to be able to contact the front end surface of the impedance adjusting member 40. A length (thickness) in the front-rear direction of the spacer member 50 is sufficiently small and, for example, equal to a gap naturally formed between the impedance adjusting member 40 and the terminal 30 when the impedance adjusting member 40 is arranged near the terminal 30 in an allowable range. The spacer member 50 has a function of keeping the gap between the terminal 30 and the impedance adjusting member 40 and keeping the terminal 30 and the impedance adjusting member 40 in an insulated state.

### (Terminal Accommodating Member)

The terminal accommodating member 60 is a dielectric made of synthetic resin and has insulating property. As shown in FIG. 2, the terminal accommodating member 60 includes a lower member 61 and an upper member 62 to be attached to the lower member 61 from above. The lower member 61 includes a flat plate-like lower body portion 63 and a pair of frame-like lower lock portions 64 rising from both left and right end parts of the lower body portion 63. The upper member 62 includes a flat plate-like upper body portion 65 and a pair of rib-like upper lock portions 66 (only one is shown in FIG. 2) projecting on both left and right end parts of the upper body portion 65.

As shown in FIG. 4, the upper member 62 includes a pair of side portions 67 projecting downward from the both left and right end parts of the upper body portion 65 and a partitioning portion 68 projecting downward from a lateral central part of the upper body portion 65. Any of the respective side portions 67 and the partitioning portion 68 is plate-like and has plate surfaces facing in a lateral direction. A rear part of the upper member 62 includes a pair of the spacer accommodating portions 69 on both left and right sides across the partitioning portion 68. Each spacer member 50 is inserted and accommodated into each spacer accommodating portion 69 while being fit to the insulation coating 25 of the exposed portion 27.

The lower member 61 and the upper member 62 are held in a separation restricted state by locking the respective lower lock portions 64 to the respective upper lock portions 66. Each spacer accommodating portion 69 is defined by the lower member 61 and the upper member 62 while accommodating the spacer member 50. As shown in FIG. 4, the spacer member 50 is restricted form moving in the lateral direction by being sandwiched between the partitioning portion 68 and the side portion 67 and restricted from moving in the vertical direction by being sandwiched between the upper body portion 65 and the lower body portion 63. That is, the spacer member 50 is restricted from moving in the vertical direction and the lateral direction while being accommodated in the spacer accommodating portion 69.

### (Outer Conductor).

The outer conductor 70 is formed, such as by bending an electrically conductive metal plate. As shown in FIGS. 1 and 2, the outer conductor 70 includes a body member 71 and a cover member 72. The body member 71 includes a tube portion 73 in the form of a rectangular tube for covering the outer periphery of the terminal accommodating member 60 (lower member 61 and upper member 62 in a united state) and an extending portion 74 extending rearward from the tube portion 73. The tube portion 73 includes a plurality of resilient contact portions 75 connectable to an unillustrated mating outer conductor. As shown in FIG. 3, the extending portion 74 contacts the lower surface of the turnover portion 26 of the shield portion 22. As shown in FIG. 1, the cover member 72 is put on a rear part of the body member 71 from above. Further, the cover member 72 is bent to cover the outer periphery of the turnover portion 26 and be locked in close contact with the outer surface of the extending portion 74 (see FIG. 3). The extending portion 74 and the cover member 72 are electrically and mechanically connected to the shield portion 22, whereby the outer conductor 70 can constitute a part of a ground circuit. Each terminal 30 and the outer conductor 70 are kept in an insulated state by the terminal accommodating member 60.

### (Functions of Terminal Module)

An example of a manufacturing method of the terminal module 10 is described below. First, the exposed portion 27 of each coated wire 21 is inserted into the wire insertion hole 51 of each spacer member 50. In that state, the wire barrel portion 32 of each terminal 30 is crimped to the core wire 24 of the exposed portion 27 of each coated wire 21, and the insulation barrel portion 33 of each terminal 30 is crimped to the insulation coating 25 of the exposed portion 27 of each coated wire 21. Subsequently, the front surface of each spacer member 50 is butted against the rear end surface of the insulation barrel portion 33. Further, the front end of each adjusting body portion 41 of the impedance adjusting member 40 in an open state is butted against the rear surface of each spacer member 50 and, in that state, each adjusting body portion 41 is bent.

In the above way, each adjusting body portion 41 is crimped to the insulation coating 25 of the exposed portion 27 of each coated wire 21 and the front end of each adjusting body portion 41 can be brought into contact with the rear surface of each spacer member 50. Each spacer member 50 is arranged with a position shift in the front-rear direction with respect to the insulation coating 25 of the exposed portion 27 of each coated wire 21 restricted by being sandwiched in the front-rear direction between the insulation barrel portion 33 of each terminal 30 and each adjusting body portion 41 of the impedance adjusting member 40 (see FIG. 3). A predetermined gap (gap determined in advance and fixed among products) corresponding to the length (thickness) in the front-rear direction of each spacer member 50 is kept between the insulation barrel portion 33 of each terminal 30 and each adjusting body portion 41 of the impedance adjusting member 40.

Thereafter, the respective terminals 30 are accommodated in both left and right spaces across the partitioning portion 68 in the upper member 62, the respective spacer members 50 are accommodated in the respective spacer accommodating portions 69 and the upper member 62 and the lower portion are held in the united state. By accommodating each spacer member 50 into each spacer accommodating portion 69, movements of each spacer member 50 are restricted as described above (see FIG. 4).

As described above, the terminal module 10 according to the first embodiment is provided with the insulating spacer member 50 for keeping the gap between the terminal 30 and the impedance adjusting member 40. Since the spacer member 50 prevents the contact (short circuit) of the terminal 30 and the impedance adjusting member 40 and keeps the gap between the terminal 30 and the impedance adjusting member 40 constant, an impedance variation can be suppressed. Since the spacer member 50 is a tubular member for covering the end region (exposed portion 27) of the coated wire 21, signal reflection in the end region of the coated wire 21 can be effectively suppressed.

Further, the spacer member 50 is sandwiched between the terminal 30 and the impedance adjusting member 40 and held with a position shift in the front-rear direction, which is a length direction of the coated wire 21, restricted. Further, the spacer member 50 is accommodated in the spacer accommodating portion 69 of the terminal accommodating member 60 with movements thereof restricted. Thus, the position of the spacer member 50 with respect to each of the terminal 30 and the impedance adjusting member 40 can be determined and, in addition, the rattling of the spacer member 50 with respect to the terminal accommodating member 60 can be restricted. Thus, the configuration of the first embodiment can stably keep the gap between the terminal 30 and the impedance adjusting member 40 via the spacer member 50 and more effectively suppress an impedance variation.

Further, in the case of the first embodiment, the spacer members 50 are provided to individually cover the respective coated wires 21 extending from the two terminals 30. Thus, in the case of changing one coated wire 21, out of the two coated wires 21, it is sufficient to exchange only the spacer member 50 corresponding to the one coated wire 21 and the spacer member 50 corresponding to the other coated wire 21 needs not be exchanged.

### Second Embodiment

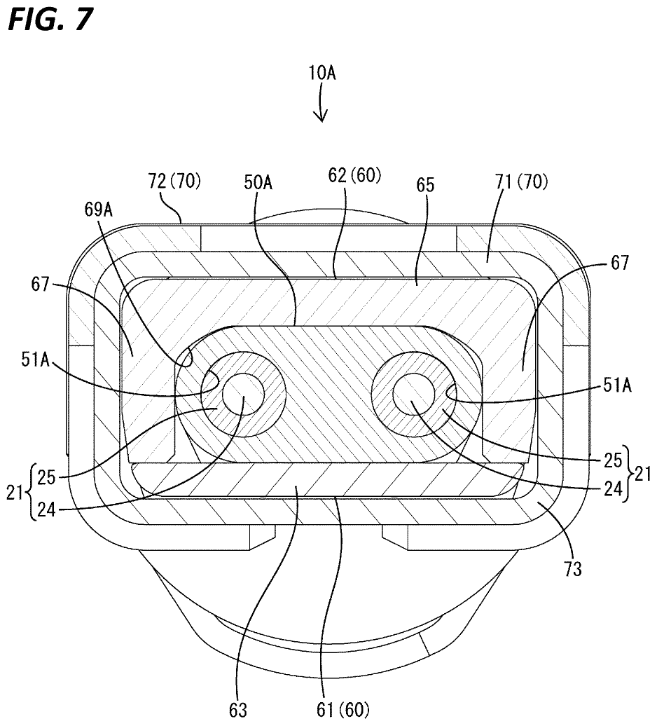

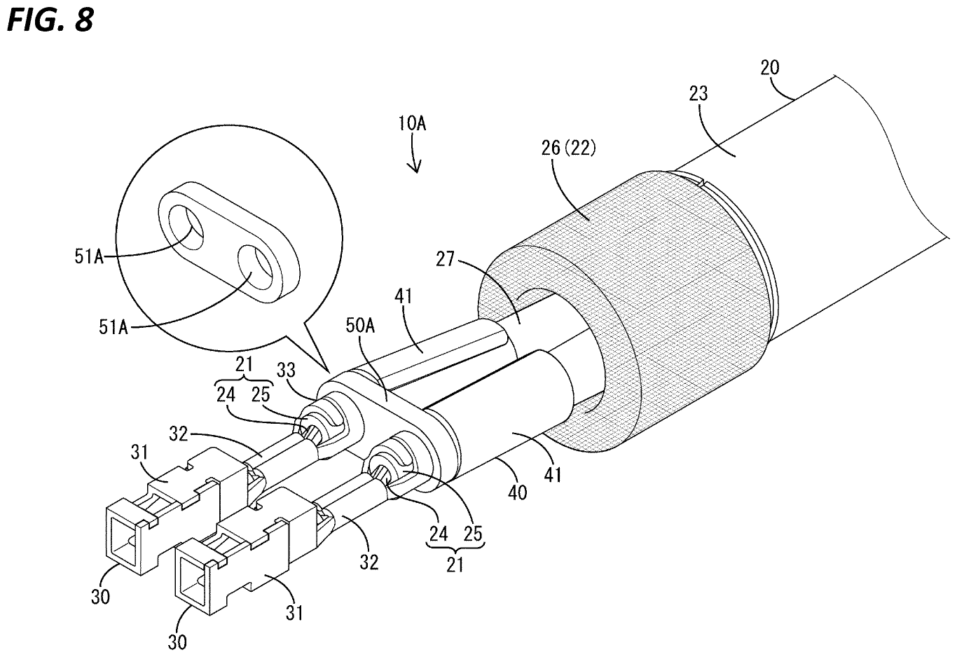

A terminal module 10A according to a second embodiment of the present disclosure is different from that of the first embodiment in a spacer member 50A and a spacer accommodating portion 69A for accommodating the spacer member 50A as shown in FIGS. 7 and 8. The other configuration is similar to the first embodiment. In the following description of the second embodiment, the same or corresponding structures as those of the first embodiment are denoted by the same reference signs and repeated description is omitted.

The spacer member 50A is of an integrated type for collectively covering end regions (exposed portions 27) of respective coated wires 21. The spacer member 50A is plate-like and has a thickness in the front-rear direction. Specifically, the spacer member 50A has a track-like cross-sectional shape and has straight upper and lower surfaces extending along the lateral direction and left and right side surfaces curved and extending in the vertical direction. The thickness in the front-rear direction of the spacer member 50A is equal to that of the spacer member 50A of the first embodiment and is a size capable of keeping a predetermined gap between a terminal 30 and an impedance adjusting member 40.

The front and rear surfaces of the spacer member 50A are both formed along a radial direction of the spacer member 50A. The front surface of the spacer member 50A is arranged to be able to contact the rear end surfaces of insulation barrel portions 33 of the terminals 30. The rear surface of the spacer member 50A is arranged to be able to contact the front end surface of the impedance adjusting member 40.

The spacer member 50A includes a plurality of (two in the second embodiment) wire insertion holes 51A corresponding to the number of the respective coated wires 21. The respective wire insertion holes 51A penetrate through the spacer member 50A side by side at an interval in the lateral direction. An inner diameter of each wire insertion hole 51A is equal to that of the spacer member 50A of the first embodiment.

A rear part of a terminal accommodating member 60 includes one spacer accommodating portion 69A not including a part corresponding to the partitioning portion 68 of the first embodiment as shown in FIG. 7. The spacer member 50A is accommodated into the spacer accommodating portion 69A, restricted from moving in the lateral direction by being sandwiched between left and right side portions 67 and restricted from moving in the vertical direction by being sandwiched between an upper body portion 65 and a lower body portion 63. That is, the spacer member 50A is restricted from moving in the vertical direction and the lateral direction while being accommodated in the spacer accommodating portion 69A.

According to the second embodiment, as in the first embodiment, an impedance variation can be suppressed since the insulating spacer member 50A keeps the gaps between the respective terminals 30 and the impedance adjusting member 40. Further, in the case of the second embodiment, since the spacer member 50A keeps a gap between the respective exposed portions 27 adjacent in the lateral direction constant, the occurrence of crosstalk and the like of the respective exposed portions 27 adjacent in the lateral direction can be prevented and impedance matching can be improved.

### Third Embodiment

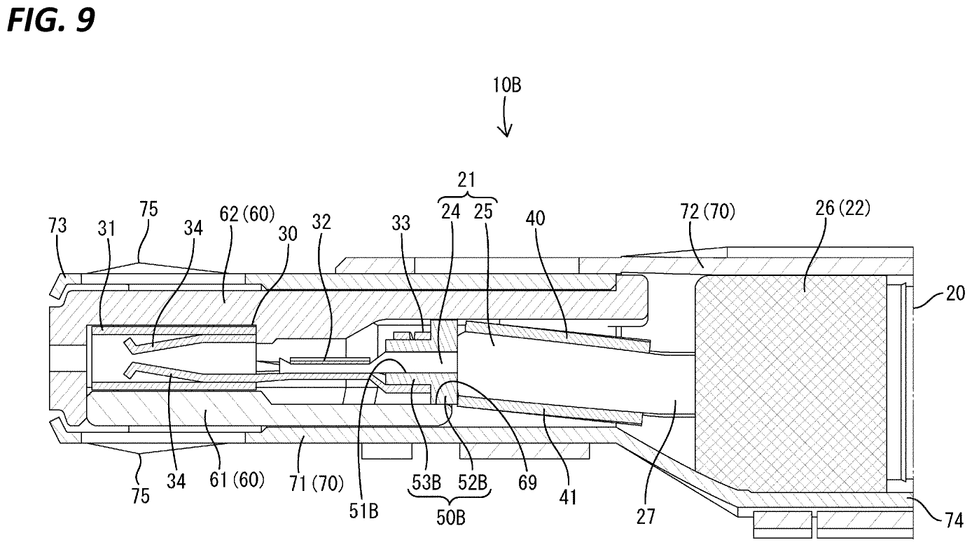

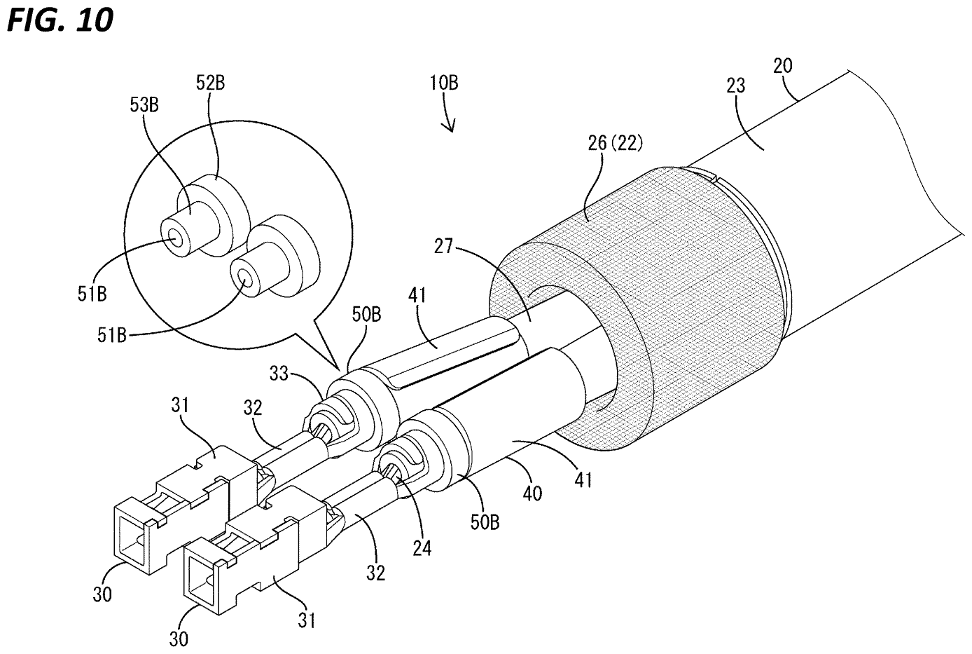

A terminal module 10B according to a third embodiment of the present disclosure is different from that of the first embodiment in spacer members 50B as shown in FIGS. 9 and 10. Further, in an end region (exposed portion 27) of each coated wire 21, a projection amount of a core wire 24 projecting from an insulation coating 25 is longer than in the first embodiment. The other configuration is similar to the first embodiment. In the following description of the third embodiment, the same or corresponding structures as those of the first embodiment are denoted by the same reference signs and repeated description is omitted.

The spacer member 50B has a top hat shape (convex shape) in a side view and includes a spacer body portion 52B and a fixing portion 53B projecting forward from the spacer body portion 52B. The spacer body portion 52B has a tubular or annular shape, e.g. a hollow cylindrical shape or a circular ring shape. The fixing portion 53B similarly has a tubular or annular shape, e.g. a hollow cylindrical shape or a circular ring shape. The fixing portion 53B is one size smaller than the spacer body portion 52B and has an outer peripheral surface concentric with the spacer body portion 52B in a front view.

The front and rear surfaces of the spacer body portion 52B are both formed along a radial direction of the spacer member 50B. The front surface of the spacer body portion 52B is connected at a right angle to the outer peripheral surface of the fixing portion 53B. The outer peripheral surface of the fixing portion 53B is formed along the front-rear direction. The front surface of the spacer body portion 52B is arranged to be able to contact the rear end surface of an insulation barrel portion 33 of a terminal 30. The rear surface of the spacer body portion 52B is arranged to be able to contact the front end surface of an impedance adjusting member 40. The outer peripheral surface of the fixing portion 53B is arranged to be able to closely contact the insulation barrel portion 33 of the terminal 30.

The spacer member 50B includes a wire insertion hole 51B penetrating in the front-rear direction from the spacer body portion 51B to the fixing portion 53B inside. The wire insertion hole 51B has an inner diameter corresponding to an outer diameter of the core wire 24 exposed in an end part of the exposed portion 27.

In the case of the third embodiment, the spacer member 50B is provided to individually cover the end region (exposed portion 27) of each coated wire 21 as in the first embodiment. On the other hand, unlike the first embodiment, the core wire 24 exposed in the end part of the exposed portion 27 is inserted into the wire insertion hole 51B of the spacer member 50B. The fixing portion 53B of the spacer member 50B is crimped by the insulation barrel portion 33 and fixed (held) in a state compressed in a radial direction between the insulation barrel portion 33 and the core wire 24. The rear surface of the spacer body portion 52B is arranged to be able to contact the front end surface of the impedance adjusting member 40 and arranged to be able to contact the front end surface of the insulation coating 25 (see FIG. 9).

According to the third embodiment, since the insulating spacer member 50B keeps a gap between the terminal 30 and the impedance adjusting member 40 as in the first embodiment, an impedance variation can be suppressed. Further, in the case of the third embodiment, the spacer member 50B includes the fixing portion 53B to be sandwiched and held in the radial direction of the coated wire 21 between the end region (exposed portion 27) of the coated wire 21 and the insulation barrel portion 33. Thus, the configuration of the third embodiment can keep the relative position of the spacer member 50B with respect to each of the coated wire 21 and the terminal 30 constant and more effectively suppress an impedance variation. Particularly, the fixing portion 53B has a tubular shape for covering the core wire 24 projecting from the insulation coating 25 in the end part of the coated wire 21 and can fulfill a function of the insulation coating 25 of the coated wire 21. As a result, a radial dimension of the insulation barrel portion 33 in a crimped state (closed state) can be suppressed.

### Fourth Embodiment

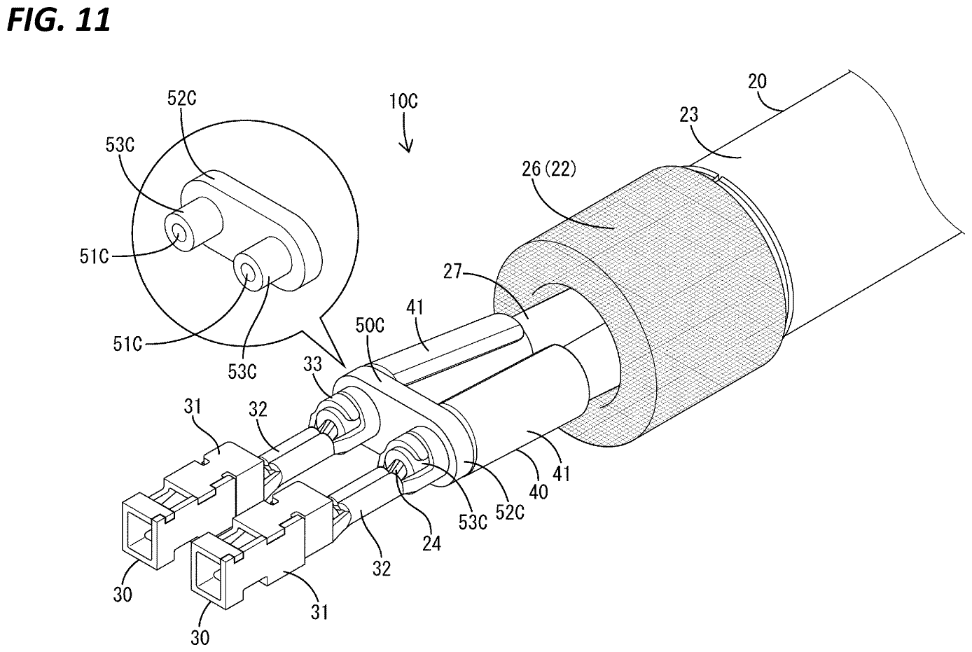

A terminal module 10C according to a fourth embodiment of the present disclosure is provided with a spacer member 50C of an integrated type for collectively covering end regions (exposed portions 27) of respective coated wires 21 as shown in FIG. 11. The spacer member 50C includes a plate-like spacer body portion 52C having a thickness in the front-rear direction. The spacer member 50C has a track-like cross-sectional shape and has an outer shape similar to that of the spacer member 50A of the second embodiment.

The spacer member 50C includes two fixing portions 53C projecting forward from the spacer body portion 52C. The respective fixing portions 53C project side by side at an interval in the lateral direction in the spacer body portion 52C. Each fixing portion 53C has a shape similar to that of the fixing portion 53B of the third embodiment.

The spacer member 50C includes two wire insertion holes 51C penetrating in the front-rear direction from the spacer body portion 52C to the respective fixing portions 53C. Each wire insertion hole 51C has an inner diameter corresponding to an outer diameter of a core wire 24 exposed in an end part of the exposed portion 27, similarly to the wire insertion hole 51B of the third embodiment.

In the case of the fourth embodiment, the core wire 24 exposed in the end part of the exposed portion 27 of each coated wire 21 is inserted into each wire insertion hole 51C. The front end surface of an insulation coating 25 in the end part of each coated wire 21 is arranged to be able to contact the rear surface of the spacer body portion 52C. Further, the front end surface of the impedance adjusting member 40 is also arranged to be able to contact the rear surface of the spacer body portion 52C. Each fixing portion 53C is crimped by an insulation barrel portion 33 of each terminal 30 and fixed (held) in a state compressed in a radial direction between the insulation barrel portion 33 and the core wire 24.

According to the fourth embodiment, as in the first embodiment, an impedance variation can be suppressed since the insulating spacer member 50C keeps gaps between the terminals 30 and the impedance adjusting member 40. Further, in the case of the fourth embodiment, since the spacer member 50C keeps a gap between the respective exposed portions 27 adjacent in the lateral direction constant, the occurrence of crosstalk and the like of the respective exposed portions 27 adjacent in the lateral direction can be prevented and impedance matching can be improved. Further, the relative position of the spacer member 50C with respect to each of the coated wire 21 and the terminal 30 can be kept constant by each fixing portion 53C and an impedance variation can be more effectively suppressed. Particularly, each fixing portion 53C has a tubular shape for covering the core wire 24 projecting from the insulation coating 25 in the end part of the coated wire 21, wherefore each fixing portion 53C can fulfill a function of the insulation coating 25 of the coated wire 21.

### Fifth Embodiment

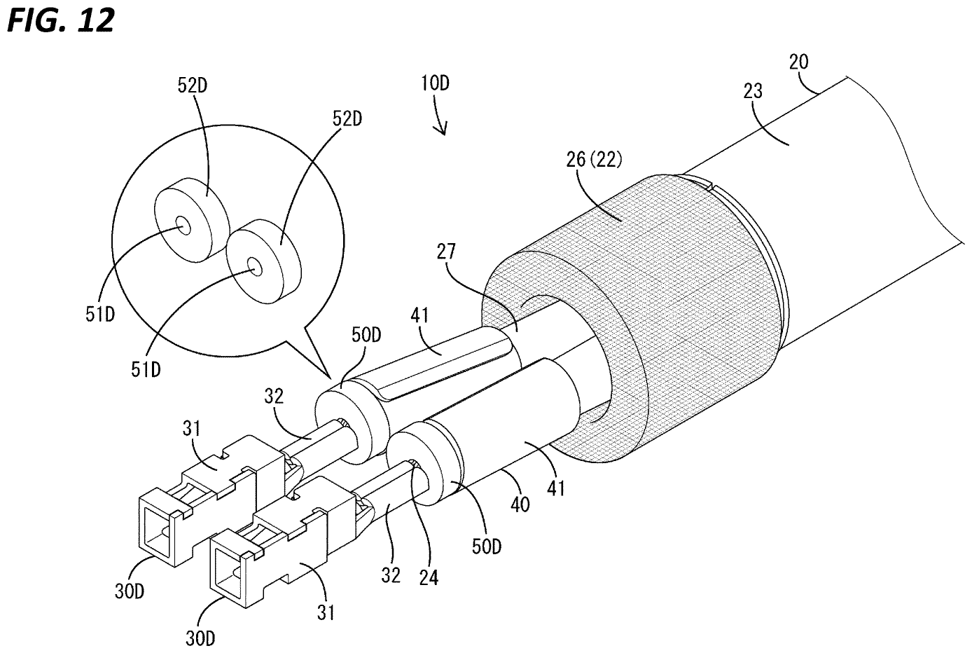

A terminal 10D according to a fifth embodiment of the present disclosure is provided with spacer members 50D for individually covering end regions (exposed portions 27) of respective coated wires 21 and terminals 30D not including a part corresponding to the insulation barrel portion 33 of the first embodiment as shown in FIG. 12.

A barrel portion of the terminal 30D is composed only of a wire barrel portion 32. The terminal 30D is shorter in the front-rear direction than the terminal 30 of the first embodiment since not including the part equivalent to the insulation barrel portion 33. The rear end surface of the wire barrel portion 32 serves as the rear end surface of the terminal 30D.

The spacer member 50D has a tubular or annular shape, e.g. a hollow cylindrical shape or a circular ring shape. The spacer member 50D has an outer shape similar to that of the spacer member 50 of the first embodiment.

The spacer member 50D includes a wire insertion hole 51D. An inner diameter of the wire insertion hole 51D corresponds to an outer diameter of a core wire 24 exposed in an end part of an exposed portion 27. The core wire 24 exposed in the exposed portion 27 is inserted into the wire insertion hole 51D. The front surface of the spacer member 50D is arranged to be able to contact the rear end surface of the wire barrel portion 32. The rear surface of the spacer member 50D is arranged to be able to contact the front end surface of an impedance adjusting member 40. Further, the rear surface of the spacer member 50D is arranged to be able to contact the front end surface of an insulation coating 25 of the exposed portion 27.

According to the fifth embodiment, the insulating spacer member 50D is sandwiched and held between the wire barrel portion 32 of the terminal 30D and the impedance adjusting member 40 with movements restricted. Since a gap between the terminal 30D and the impedance adjusting member 40 is kept as in the first embodiment, an impedance variation can be suppressed. Further, since the barrel portion of the terminal 30D is composed only of the wire barrel portion 32 in the case of the fifth embodiment, the terminal 10D can be shortened in the front-rear direction.

### Sixth Embodiment

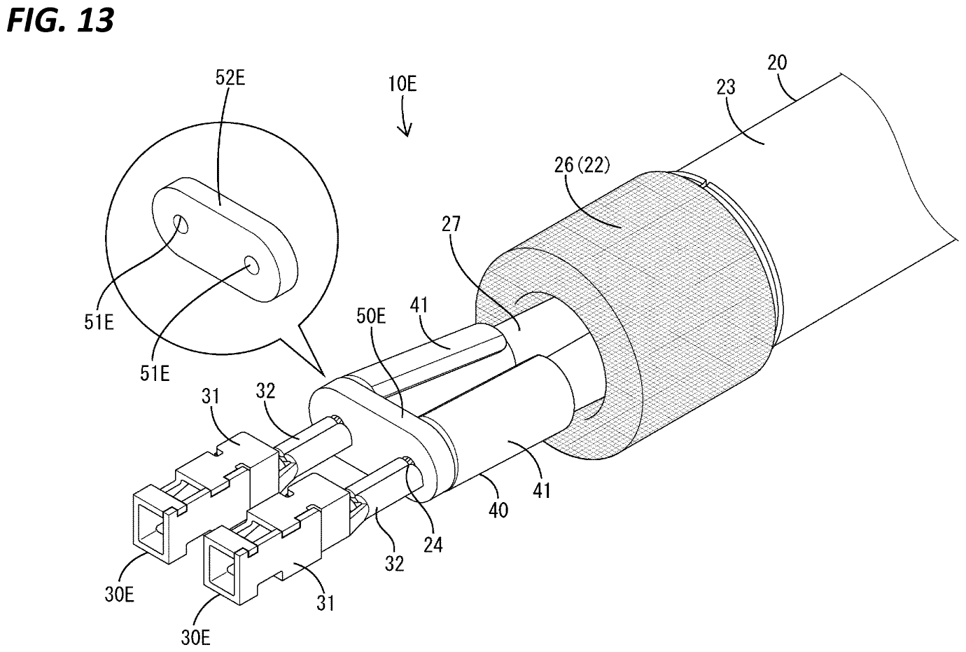

A terminal module 10E according to a sixth embodiment of the present disclosure is provided with a spacer member 50E of an integrated type for collectively covering end regions (exposed portions 27) of respective coated wires 21 and terminals 30E not including a part equivalent to the insulation barrel portion 33 of the first embodiment as shown in FIG. 13.

A barrel portion of the terminal 30E is composed only of a wire barrel portion 32. The rear end surface of the wire barrel portion 32 serves as the rear end surface of the terminal 30E.

The spacer member 50E is plate-like and has a thickness in the front-rear direction. The spacer member 50E has a track-like cross-sectional shape and has an outer shape similar to that of the spacer member 50A of the second embodiment. The spacer member 50E includes two wire insertion holes 51E. The respective wire insertion holes 51E penetrate through the spacer member 50E while being arranged at an interval in the lateral direction. An inner diameter of each wire insertion hole 51E corresponds to an outer diameter of a core wire 24 exposed in an end part of each exposed portion 27. The core wire 24 exposed in the end part of each exposed portion 27 is inserted into each wire insertion hole 51E.

The spacer member 50E is sandwiched and held between the wire barrel portion 32 of each terminal 30E and an impedance adjusting member 40 with movements restricted. Since a gap between each terminal 30E and the impedance adjusting member 40 is kept by the insulating spacer member 50E as in the first embodiment, an impedance variation can be suppressed. Further, since the barrel portion of the terminal 30E is composed only of the wire barrel portion 32 in the case of the sixth embodiment, the terminal 10E can be shortened in the front-rear direction. Furthermore, since the spacer member 50E keeps a gap between the exposed portions 27 adjacent in the lateral direction constant, the occurrence of crosstalk and the like between the exposed portions 27 adjacent in the lateral direction can be prevented and impedance matching can be improved.

### Other Embodiments of Present Disclosure

The above first to sixth embodiments disclosed this time should be considered illustrative in all aspects, rather than restrictive.

In the case of the above first to six embodiments, the spacer member is shaped to cover the entire outer periphery of the end region of the coated wire. In contrast, according to another embodiment, a spacer member may have a part partially not covering the outer periphery of the end region of the coated wire and may be, for example, formed into a C-shaped cross-section.

In the case of the above third, fourth and sixth embodiments, the spacer member includes the tubular fixing portion for covering the outer periphery of the core wire exposed in the end part of the coated wire. In contrast, according to another embodiment, a spacer member may include a tubular fixing portion for covering the outer periphery of the insulation coating in the end part of the coated wire.

In the case of the above first to six embodiments, two terminals and two coated wires are accommodated in one terminal accommodating member. In contrast, according to another embodiment, one, three or more terminals and one, three or more coated wires may be accommodated in one terminal accommodating member.

### LIST OF REFERENCE NUMERALS

10, 10A, 10B, 10C, 10D, 10E . . . terminal
20 . . . shielded cable
21 . . . coated wire
22 . . . shield portion
23 . . . sheath
24 . . . core wire
25 . . . insulation coating
26 . . . turnover portion
27 . . . exposed portion
30, 30D, 30E . . . terminal
31 . . . mating connecting portion
32 . . . wire barrel portion (barrel portion)
33 . . . insulation barrel portion (barrel portion)
34 . . . connection piece
40 . . . impedance adjusting member
41 . . . adjusting body portion
42 . . . coupling portion
50, 50A, 50B, 50C, 50D, 50E . . . spacer member
51, 51A, 51B, 51C, 51D, 51E . . . wire insertion hole
52B, 52C . . . spacer body portion
53B, 53C . . . fixing portion
60 . . . terminal accommodating member
61 . . . lower member
62 . . . upper member
63 . . . lower body portion
64 . . . lower lock portion
65 . . . upper body portion
66 . . . upper lock portion
67 . . . side portion
68 . . . partitioning portion
69, 69A . . . spacer accommodating portion
70 . . . outer conductor
71 . . . body member
72 . . . cover member
73 . . . tube portion
74 . . . extending portion
75 . . . resilient contact portion

1. A terminal module, comprising:
a shielded cable configured such that an end part of a coated wire is exposed from a shield portion;
a terminal to be connected to the end part of the coated wire;
an electrically conductive impedance adjusting member for covering an end region of the coated wire; and
an insulating spacer member for keeping a gap between the terminal and the impedance adjusting member.

2. The terminal module of claim 1, wherein the spacer member is a tubular member for covering the end region of the coated wire between the terminal and the impedance adjusting member.

3. The terminal module of claim 1, wherein the spacer member is arranged with a position shift in a length direction of the coated wire restricted by the terminal and the impedance adjusting member.

4. The terminal module of claim 1, further comprising an insulating terminal accommodating member for accommodating the terminal, wherein:
the terminal accommodating member includes a spacer accommodating portion for accommodating the spacer member with movements of the spacer member restricted.

5. The terminal module of claim 4, wherein:
at least two terminals are accommodated in the terminal accommodating member, and the spacer members are provided to individually cover the respective end regions of the coated wires extending from the two terminals.

6. The terminal module of claim 4, wherein:
at least two terminals are accommodated in the terminal accommodating member, and
the spacer member is integrally provided to collectively cover the respective end regions of the coated wires extending from the two terminals.

7. The terminal module of claim 4, wherein:
the terminal includes a barrel portion for holding the end part of the coated wire, and
the spacer member includes a fixing portion to be sandwiched and fixed in a radial direction of the coated wire between the end part of the coated wire and the barrel portion.

8. The terminal module of claim 7, wherein:
the coated wire includes a core wire and an insulation coating surrounding an outer periphery of the core wire, and
the fixing portion has a tubular shape for covering the core wire projecting from the insulation coating in the end part of the coated wire.
